(19) United States
(12) Patent Application Publication
(10) Pub. No.: US 2026/0234903 A1
(43) Pub. Date: Aug. 13, 2026

(54) WORK MACHINE AND METHOD FOR AUTOMATED CONFIGURATION SUPPORT BASED ON SELECTABLE MACHINE OPERATIONS

(71) Applicant: Deere & Company, Moline, IL (US)

(72) Inventors: RYAN J. KRUSE, Dubuque, IA (US); JOSEPH B. FOCHS, Dubuque, IA (US)

(21) Appl. No.: 19/048,873

(22) Filed: Feb. 8, 2025

(51) Int. Cl. E02F 9/20; E02F 3/76; E02F 3/84; E02F 9/26; G05B 13/02; G07C 5/10

(52) U.S. Cl. CPC E02F 9/2037; E02F 9/2045; E02F 9/26; G05B 13/0265; G07C 5/10; E02F 3/7636; E02F 3/841; E02F 3/844

(57) ABSTRACT

A system and method are provided for automated setup of a work machine for performance of an upcoming operation. User interface fields enable user input via a display unit associated with the work machine. Responsive to first user input corresponding to selection of a current operation, a group of selectable configurations are generated based on the current operation. Responsive to second user input corresponding to selection of one of the selectable configurations, respective target values are automatically set for work machine operating parameters based on the selected configuration. The operating parameters may be automatically controlled based on the respective target values, or the operator prompted by the system to manually control operating parameters to meet the target values. Such a system may for example quickly advise less experienced operators on the suggested machine configurations for their job function, and/or help speed up the configuring of machines for experienced operators.

### FIELD OF THE DISCLOSURE

The present disclosure relates generally to work machines having different configurations suitable for the performance of different operations, and more particularly to systems and methods for enabling configuration decision support for operators based on selected machine operation types.

### BACKGROUND

The term “work machine” as used herein may typically relate to machines performing operations in the context of construction (e.g., excavators, loaders), agriculture (e.g., combine harvesters, windrowers, sprayers), forestry (e.g., feller bunchers), and the like, self-propelled or otherwise, but may further include various alternative forms of work machines in other fields as may be understood by one of skill in the art upon review of the present disclosure. Motor graders are used herein as the illustrative example of such work machines, but are in no way intended as being limited to such, unless otherwise specifically noted herein.

Such work machines have become increasingly complex to properly configure and operate, and it likewise has become increasingly difficult to find and retain qualified operators for such work machines. Often for conventional applications, operators either must learn by trial and error or through mentorship from an experienced operator (who may or may not be available to assist at the time a job needs to be completed). For example, because of the different requirements placed on a work machine in the context of individual operations which are capable of being performed, it is often necessary to use different configurations of the work machine along with corresponding work machine operating parameters for the various operations.

### BRIEF SUMMARY

The current disclosure provides an enhancement to conventional systems, at least in part by introducing a novel system and method for quickly advising less experienced operators on the suggested machine configurations for their job function, and/or helping to speed up the configuration of a work machine for experienced operators.

In a first exemplary embodiment, a computer-implemented method as disclosed herein is provided for automated setup of a work machine for performance of an upcoming operation. One or more user interface fields are generated, enabling user input via a display unit associated with the work machine. Responsive to first user input corresponding to selection of a current operation, a group of one or more selectable configurations are generated based on the current operation. Responsive to second user input corresponding to selection of one of the one or more selectable configurations, the method further includes automatically setting respective target values for one or more work machine operating parameters based on the selected one of the one or more selectable configurations. The work machine may for example achieve the selected configuration as defined in a vehicle controller (e.g., using in-cylinder position sensing, inertial measurement units (IMUs), steering angle sensors, articulation angle sensors, etc.).

In one optional aspect according to the above-referenced first embodiment, the one or more work machine operating parameters may be automatically controlled during the operation of the work machine based on the respective target values.

In another optional aspect according to the above-referenced first embodiment, at least one of the one or more work machine operating parameters are associated with a position and/or orientation of a work machine implement for working a ground surface during the current operation.

In another optional aspect according to the above-referenced first embodiment, at least one of the one or more work machine operating parameters are associated with a specified path to be traversed by the work machine during at least a current portion of the current operation.

In another optional aspect according to the above-referenced first embodiment, feedback may be automatically generated for prompting manual control of at least one of the one or more work machine operating parameters during or prior to the operation of the work machine based on the respective target values. Such feedback may for example be provided audibly, visually, or via vibration or haptic feedback to the operator.

In another optional aspect according to the above-referenced first embodiment, the at least one of the one or more work machine operating parameters are associated with a position and/or orientation of a work machine implement for working a ground surface during the current operation.

In another optional aspect according to the above-referenced first embodiment, the at least one of the one or more work machine operating parameters are associated with a specified path to be traversed by the work machine during at least a current portion of the current operation.

In another optional aspect according to the above-referenced first embodiment, a learning stage is provided wherein historical input data sets are generated over time with respect to associated operations, configurations, and operating parameters, and wherein one or more models and/or algorithms are developed and/or trained to correlate the historical input data sets with observed outcomes. One of the one or more models and/or algorithms may accordingly be retrieved in association with the selected current operation and/or the selected one of the one or more selectable configurations, and the respective target values for the one or more work machine operating parameters in association with the current operation may be automatically set based at least in part on reference to the retrieved one of the one or more models and/or algorithms.

In another optional aspect according to the above-referenced first embodiment, one or more outcomes of performance of the current operation may be observed, and feedback for further development and/or training of the one or more models and/or algorithms may be provided based on the observed one or more outcomes and at least the corresponding target values for the one or more work machine operating parameters.

In another optional aspect according to the above-referenced first embodiment, the observed one or more outcomes may comprise a determined speed of performance for the selected current operation, and/or a determined precision of the work machine in performing to target specifications for the selected current operation, and/or a determined efficiency in performance of the selected current operation.

In another optional aspect according to the above-referenced first embodiment, the selected one of the one or more selectable configurations may correspond to a current portion of the selected operation, the method comprising determining or predicting completion of the current portion and generating a prompt for further user input corresponding to selection of a configuration for a subsequent portion of the selected operation.

In another optional aspect according to the above-referenced first embodiment, the one or more user interface fields may comprise a first user interface field including a group of one or more selectable operations, wherein the first user input comprises selection of one of the one or more selectable operations via the first user interface field.

In another optional aspect according to the above-referenced first embodiment, the one or more selectable configurations may comprise at least one operating mode wherein the target values are automatically set for prioritizing a speed of performance for the operation, and/or at least one operating mode wherein the target values are automatically set for prioritizing a precision of the work machine in performing to target specifications for the operation, and/or at least one operating mode wherein the target values are automatically set for prioritizing an efficiency in performance of the operation.

In a second exemplary embodiment according to the present disclosure, a work machine may be provided including a frame supported by a plurality of ground-engaging units for propulsion of the work machine, an implement controllably moveable relative to the frame, and one or more processors configured to direct the performance of steps in the above-referenced first embodiment, and optionally one or more of the described aspects thereof.

In a third exemplary embodiment according to the present disclosure, a system may be provided which comprises one or more processors configured to direct the performance of steps in the above-referenced first embodiment, and optionally one or more of the described aspects thereof. The one of more processors in such a system may for example reside on a work machine to be configured for an upcoming operation, such as for example part of a machine control system, may be part of a cloud server network, may reside on one or more user computing devices, or some combination thereof.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view representing a motor grader as an exemplary work machine according to an embodiment as disclosed herein.

FIGS. 2A-2I are various top views representing different configurations of the work machine of FIG. 1.

FIG. 3 is a block diagram representing an exemplary control system according to an embodiment as disclosed herein.

FIG. 4 is a flowchart representing an exemplary method according to an embodiment as disclosed herein.

### DETAILED DESCRIPTION

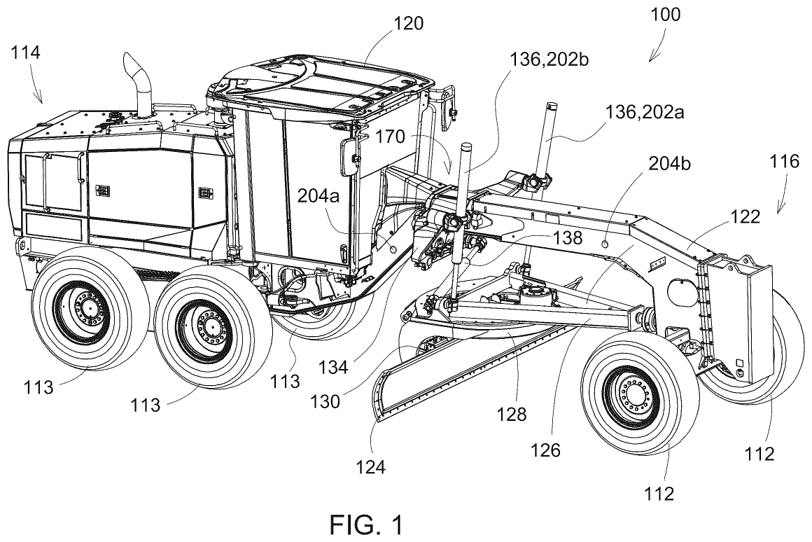

Referring now to FIGS. 1-4, various embodiments may now be described of a system and method for configuring and operating a work machine.

FIG. 1 in one illustrative embodiment as disclosed herein shows a representative work machine 100 in the form of, for example, a motor grader which has two front traction wheels 112 and four rear traction wheels 113. The work machine 100 has rear and front portions 114, 116, respectively. An engine frame 121 of the rear portion 114 and a main frame 122 of the front portion 116 are articulated to one another at an articulation joint 170 for steering of the self-propelled work machine 100 left and right using respective articulation cylinders (not shown) that are coupled to and extending between the rear and front portions 114, 116. As used herein, terms such as “left” and “right” may generally be considered relative to a central fore-aft axis of the work machine 100.

The rear portion 114 includes an internal combustion engine (e.g., diesel engine) to power the work machine 100 and a tandem on each side of the vehicle 100, only the left tandem being illustrated. Each tandem has two traction wheels 113 that may be driven by the engine of the work machine 100 through a transmission for propulsion of the work machine 100, each tandem having a chain drive with two chains each between a tandem axle and a respective wheel 113. The rear portion 114 thus has four of the six traction wheels of the self-propelled work machine 100, two on the left with one in front of the other and two on the right with one in front of the other.

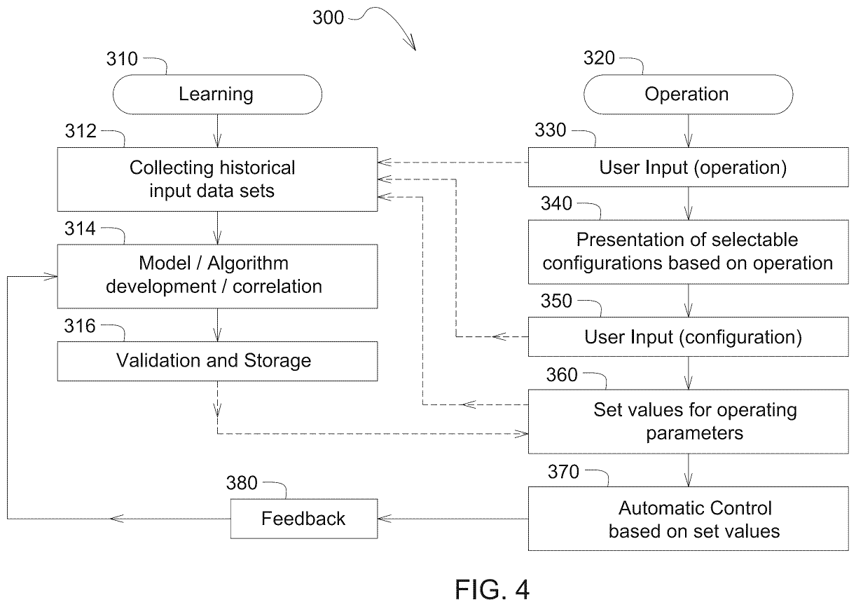

The front portion 116 has an operator's station 120 from which a human operator can control various operations of the work machine 100. The operator's station 120 may include a user interface 214 (not shown in FIG. 1 but represented as part of the control system 200 in FIG. 4). The term “user interface” 214 as used herein may broadly take the form of or otherwise include a display unit 216 and/or other outputs from the system such as indicator lights, audible alerts, and the like. The user interface may further or alternatively include various controls or user inputs (e.g., a steering wheel, joysticks, levers, buttons) for operating the work machine 100, including operation of the engine, hydraulic cylinders, and the like. Such an onboard user interface may be coupled to a vehicle control system via for example a CAN bus arrangement or other equivalent forms of electrical and/or electro-mechanical signal transmission. Another form of user interface (not shown) may take the form of a display that is generated on a remote (i.e., not onboard) computing device 242, which may display outputs such as status indications and/or otherwise enable user interaction such as the providing of inputs to the system. In the context of a remote user interface, data transmission between for example the vehicle control system and the user interface may take the form of a wireless communications system and associated components as are conventionally known in the art.

The front portion 116 of the work machine 100 supports a work implement 124, which in the shown embodiment of FIG. 1 takes the form of a moldboard 124, mounted to the main frame 122 of the front portion 116. The moldboard 124 is configured for moving earthen or other material, e.g., to create a desired contour of the ground surface, and may be mounted for movement in a number of directions, including translational movement, roll, pitch, and yaw. A draft frame 126 is coupled to the main frame 122 toward the front via a ball-and-socket joint. A circle frame 128 is coupled to the draft frame 126 to rotate relative thereto by use of a circle drive 129 mounted to the draft frame 126. A tilt frame 130 holds the moldboard 124 and is coupled pivotally to the circle frame 128 for pivotal movement of the tilt frame 130 and the moldboard 124 held thereby relative to the circle frame 128 about a tilt axis by use of a tilt cylinder (not shown). The tilt cylinder is connected to the circle frame 128 and the tilt frame 130 therebetween to change the pitch of the tilt frame 130, and thus the moldboard 124, relative to the circle frame 128. The moldboard 124 is coupled to the circle frame 128 through the tilt frame 130 to rotate with the circle frame 128 relative to the draft frame 126.

A saddle 134 is mounted to the main frame 122. Left and right lift cylinders 136 (only the left lift cylinder is shown) are connected to the saddle 134 and the draft frame 126 there between as hydraulic actuators for raising and lowering the sides of the draft frame 126, and thus the moldboard 124, relative to the main frame 122. For example, the left and right lift cylinders 136 can raise and lower the draft frame 126 (i.e., in a generally vertical direction relative to the ground) by raising or lowering both the sides of the draft frame 126. Additionally, the left and right lift cylinders 136 can pivot (i.e., roll) the draft frame 126 by raising or lowering one side of the draft frame 126 relative to the other side. The left and right lift cylinders 136 may be used to adjust the roll of the moldboard 124 in order to align the moldboard 124 with the cross slope of the ground surface. The cross slope angle is the angle of the surface measured in the direction that is perpendicular to the direction the work machine 100 is traveling and relative to gravity.

The left and right lift cylinders 136 raise and lower the draft frame 126 by moving along a stroke path from an extended position to a retracted position to adjust the length of the lift cylinders 136. The length of the left and right lift cylinders 136 determines how low the draft frame 126 hangs below the main frame 122. For example, the draft frame 126 may be at a lowest position below the main frame 122 (i.e., farthest from the main frame 122) when the left and right lift cylinders 136 are fully extended to their greatest length.

A circle side-shift cylinder 138 is connected to the saddle 134 and the draft frame 126 there between to side-shift the draft frame 126 and circle frame 128, and thus the moldboard 124, relative to the main frame 122. The circle side-shift cylinder 138 is a hydraulic actuator that can sweep the draft frame 126 left and right in a back and forth direction (i.e., in a generally horizontal direction relative to the ground). In addition to sweeping the draft frame 126 horizontally left and right, the circle side-shift cylinder 138 can also rotationally sweep the draft frame 126 in the yaw direction. Specifically, when the circle side-shift cylinder 138 works in conjunction with the circle frame 128, the horizontal movement of the circle side-shift cylinder 138 combined with the rotational movement of the circle frame 128 affects the position of the draft frame 126 and moldboard 124 in the yaw direction.

A moldboard side-shift cylinder (not shown) may further be connected to the tilt frame 130 and the moldboard 124 therebetween, and operable to move the moldboard 124 in translation relative to the tilt frame 130 along a longitudinal axis of the moldboard 124.

It should be understood by those skilled in the art that the connection points of the above-referenced cylinders may be positioned at alternative locations on the work machine 100 within the scope of the present disclosure and are not limited to those specifically represented in FIG. 1.

The embodiment of a work machine 100 as represented in FIG. 1 may further include one or more position sensors, for example in the form of cylinder sensors 202 that each monitor a parameter of a corresponding cylinder 136 related to the length of that cylinder 136. For example, the work machine 100 may include cylinder sensors 202a, 202b on each of the left and right lift cylinders 136, respectively. The cylinder sensors 202a, 202b may help track the position of the left and right lift cylinders 136 along the stroke path to determine the extent to which the left and right lift cylinders 136 are extended or retracted. Thus, the cylinder sensors 202a, 202b are used to determine the length of the left and right cylinders 136 based on the length of extension of the left and right cylinders 136. The cylinder sensors 202 may be linear position sensors, encoders, or various other types of position sensors as are known in the art and configured to indicate the position of the left and right lift cylinders 136 such that the length thereof can be determined, such as for example generating signals representing a location along the axis of the cylinder 136. The first and second sensors 202 may be used to determine a change in cylinder length, for example, by identifying a change in location along the axis of the cylinder 136, or may be used to determine a change in cylinder length by measuring the amount of hydraulic fluid that is pumped through the cylinder 136.

In certain embodiments (not shown), the work machine 100 may include an additional or alternative position sensor located on the circle side-shift cylinder 138. The circle side-shift cylinder sensor may track the position of the circle side-shift cylinder 138 along the stroke path to determine the extent to which the left and right lift cylinders 136 are extended or retracted, and thus, the length of the circle side-shift cylinder 138.

In certain embodiments (not shown), the work machine 100 may include an additional or alternative position sensor on the circle frame 128. The circle frame sensor may be used to determine the degree to which the circle frame 128 is rotated about a central axis, and may for example be a rotary sensor, magnetic sensor, angular encoder, or another type of position sensor 204 capable of determining the degree of rotation of the circle frame 128.

As shown in FIG. 1, in some embodiments the work machine 100 may include one or more additional or alternative position sensors 204 located on the main frame 122, such as for example inertial measurement units (IMU's) that capture a variety of motion-and position-based measurements, including, but not limited to, velocity, acceleration, angular velocity, and angular acceleration. One example of such a sensor 204 may for example be an inertial sensor or other type of sensor capable of sensing the roll and/or pitch of the main frame 122, or for identifying relative movement between sensors.

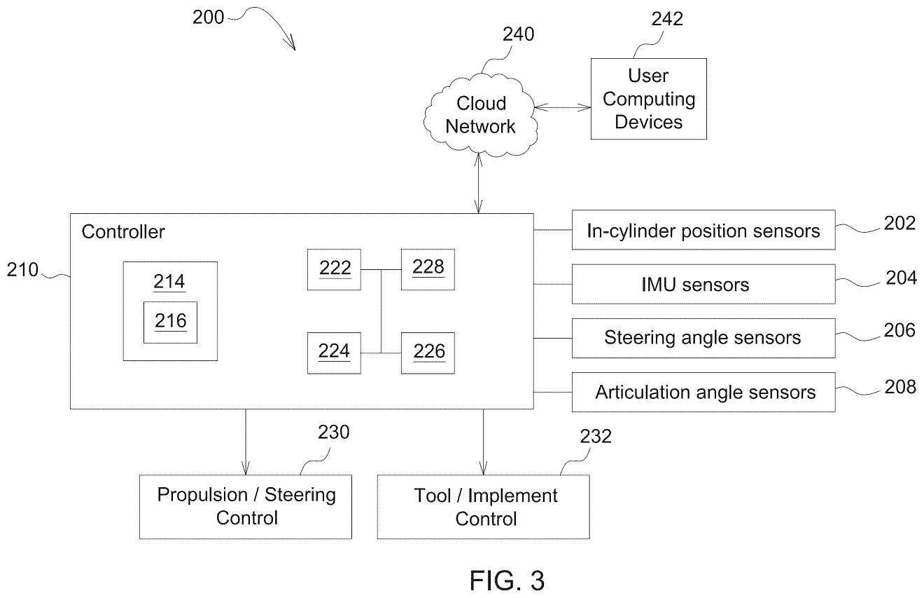

Additional position sensors which may be coupled to the work machine 100 and utilized in a control system as shown in FIG. 3 may for example include steering angle sensors 206, articulation angle sensors 208, and the like.

As will be understood by a person of ordinary skill in the art, the aforementioned position sensors may be a variety of different sensors known in the art that are capable of performing the functions described herein, dependent for example on the type of work machine, the type of operation, the type of configuration, etc. The representative functionality of one or more sensors may be replaced by machine logic or other control systems to identify a parameter that would otherwise be measured by a discrete position sensor described herein.

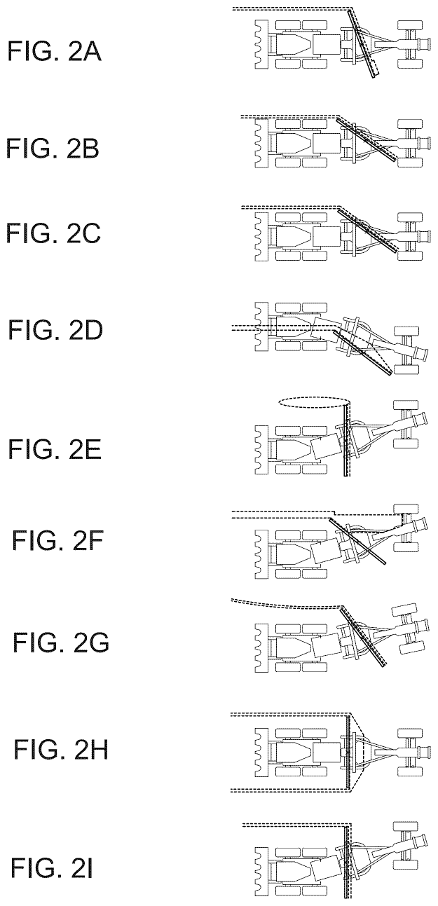

FIGS. 2A-2I illustrate merely a representative subset of possible position and/or orientation configurations for implementation by a motor grader as the work machine 100. The represented position and/or orientation configurations may specifically relate to respective positions for the moldboard/blade, circle frame, front and rear portions, and the like. It may be understood that an equivalent array of position and/or orientation configurations may be available for various other types of work machines, but the motor grader position and/or orientation configurations are used herein for illustration.

For each of various types of selectable operations that a work machine 100 is capable of performing, or otherwise which have been identified as such in a control system, the work machine may have a number of corresponding configurations for executing respective portions or variants of the operation, which may include different stages or passes to be performed in the operation, different work conditions, different local requirements, operator preference, etc.

As one example, an operator may select a v-ditching operation to be performed by a motor grader as the work machine 100. The controller may be configured to present multiple configurations for further selection, which may be of varying degrees of complexity in presentation depending on the experience of the operator, for example displaying the configurations in the form of different passes (which may generally refer to successive portions of an operation, successive paths to be traversed by the work machine, successive iterations of a portion of the operation, etc.) and a corresponding purpose for each.

In various embodiments as described herein, selectable configurations may relate at least in part to positions and/or orientations of various work machine components, and particularly a ground-engaging work implement, during relevant portions of the operation.

In certain embodiments, selectable configurations may alternatively or further relate at least in part to operating modes for the work machine. Such operating modes may for example correspond to target values which are automatically set for prioritizing one or more desired outcomes, for example a speed of performance for the operation, and/or a precision of the work machine in performing to target specifications for the operation, and/or prioritizing an efficiency in performance of the operation.

One selectable configuration may be associated with a first pass and the marking of ditch lines, wherein the position and/or orientation configuration illustrated in FIG. 2A may be associated with this selection along with specified settings of target values for parameters such as auto-differential locking, four wheel drive, gear settings for regulating maximum advance speed, and the like. Target values may for example be one of two binary options (e.g., on/off; locked/unlocked; open/closed) or may be variables, depending on the type of parameter at issue.

Another selectable configuration may be associated with a second pass and cutting of the v-ditch, for example with a specified 3-to-1 inslope, wherein the position configuration illustrated in FIG. 2B may be applied along with potential changes to one or more of the other settings. It may be understood that for subsequent passes of the operation, still further configurations may be selected and applied.

In various embodiments, as previously noted, the relative complexity of the presentation and selection process may vary in accordance with the needs of the operator. Inexperienced operators may benefit from a presentation which educates the user regarding the different options, whether in the form of illustrations, selectable detailed descriptions as pop-ups in association with the various operation or configuration options, recommendations based on previous passes in a current operation or based on previous operations in the work area, etc. More experienced operators may not require this degree of guidance, but still benefit from a presentation which enables setting of a number of work machine parameters based on a relatively small amount of user input, thereby streamlining the configuration process and reducing the potential for human error during setup.

Referring next to FIG. 3, a control system is provided in association with the work machine 100, wherein multiple inputs are provided to a controller 210 for, e.g., selecting an operation and a configuration for the work machine, automatically setting appropriate target values for machine operating parameters based on the selected configuration for the work machine, regulating control of one or more operations of the work machine 100 according to the set target values, and the like.

The controller 210 may be part of the machine control system of the working machine 100, or it may be a separate control module. Accordingly, the controller 210 may generate control signals for controlling the operation of various actuators throughout the work machine 100, which may for example include or be integrated within a travel (i.e., steering, propulsion) control unit 230 and/or a work tool/implement control unit 232 for controlling the respective operations. Electronic control signals from the controller 210 may for example be received by electro-hydraulic control valves associated with respective actuators, wherein the electro-hydraulic control valves control the flow of hydraulic fluid to and from the respective hydraulic actuators to control the actuation thereof in response to the control signal from the controller 210. The controller 210 may include or be functionally linked to the user interface 214, for example to generate text, data and/or other indicia for display on an associated display unit 216, and/or to receive user inputs from the user interface 214, and the controller 210 may optionally be mounted in the operator's station 120 at a control panel.

In addition to the specific examples of sensors 202, 204, 206, 208 previously noted herein, the controller 210 may be configured to receive input signals from various additional sensors associated with the work machine 100, including for example vehicle speed sensors, wheel tilt angle sensors, and the like, and whereas one or more of these sensors may be discrete in nature the controller 210 may receive associated signals provided from the machine control system.

A controller 210 in an embodiment may include or may be associated with a processor 222, a computer-readable medium 224, a communications unit 226, data storage 228 such as for example a database network or the like, and the aforementioned user interface 214 or control panel having a display 216. An input/output device, such as a touch screen, keyboard, joystick or other user interface tool, may be provided so that the human operator may input instructions to the controller 210. It is understood that the controller described herein may be a single controller having all of the described functionality, or it may include multiple controllers wherein the described functionality is distributed among the multiple controllers.

Various operations, steps or algorithms as described herein can be embodied directly in hardware, in a computer program product such as a software module executed by a processor 222, or in a combination of the two. The computer program product can reside in RAM memory, flash memory, ROM memory, EPROM memory, EEPROM memory, registers, hard disk, a removable disk, or any other form of computer-readable medium 224 known in the art. An exemplary computer-readable medium 224 can be coupled to the processor 222 such that the processor can read information from, and write information to, the memory/storage medium 224. In the alternative, the medium 224 can be integral to the processor 222. The processor 222 and the medium 224 can reside in an application specific integrated circuit (ASIC).

The term “processor” 222 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

A communications unit 226 may support or provide communications between the controller 210 and external systems or devices, and/or support or provide a communication interface with respect to the sensing elements and other internal components of the work machine 100. The communications unit 226 may include wireless communication system components (e.g., via cellular modem, WiFi, Bluetooth or the like) and/or may include one or more wired communications terminals such as universal serial bus ports.

An exemplary embodiment of a method 300 may next be described, with illustrative reference to FIG. 4. While the method 300 may be described with illustrative reference to a motor grader and control system as shown in FIGS. 1-3, it may be understood that various embodiments of the method 500 may be applied with respect to alternative types of work machines 100 within the scope of the present disclosure, including but not limited to excavators, bulldozers, agricultural machines, road milling machines, paving machines, and the like.

The illustrated embodiment includes a learning stage 310 and an operation stage 320, as further described below. In some embodiments the learning state 310 may be implemented for development of an algorithm to be applied in subsequent operation stages 320, or may in other embodiments for iterative training of empirical or predictive models over time. Exemplary techniques for predictive model development may include machine learning, for example supervised and unsupervised learning, hard and soft clustering, classification, forecasting, and the like. In some embodiments the learning stage 310 may be omitted, wherein for example the operation stage 320 is performed by reference to predetermined models or algorithms.

The learning stage 310 of the method 300, where included, may include a step 312 of collecting historical input data sets. An example of an input data set used for training may include an operation being performed, an associated work machine configuration, and respective values for each of one or more work machine operating parameters. Input data sets may be collected at least in part via user interface fields generated for prompting or otherwise enabling user input corresponding to at least some of the above-referenced inputs. Input data sets may be collected during operations and also used for developing, testing, training, and/or validating the models, or may be provided in some embodiments using simulation data for the sole purpose of developing, testing, training, and/or validating the models.

In some embodiments, the input data sets may further include current work conditions, such as for example an identifier for the operator, ambient conditions, or the like.

In the context where operator information is provided, embodiments of the method 300 may be capable of training a model to predict configurations of the work machine and/or corresponding work machine parameters to be applied for a given operation, based on user preferences input to the system over time. In another context, the identifier for the operator may pertain to a relative experience level, wherein the subsequent presentation may be tailored to the experience level.

The learning stage 310 of the method 300 may further include a step 314 of further developing one or more models, algorithms, or the like, wherein the collected input data sets may further be correlated with outcomes. Models or algorithms may for example be substantially empirical and/or further predictive in nature, in some embodiments enabling generation of a hierarchical list of selectable and recommended configurations based on a current operation and in some embodiments further based on a current combination of relevant factors contributing the recommendations as further described below.

The outcomes may be observed outcomes, for example based on further received inputs that may be sensed conditions, user inputs, etc. Outcomes may relate to a quality of the working result, such as for example a determined speed of performance (e.g., duration needed to perform the operation), a determined precision of performance (e.g., a maximum error in one or more aspects of the operation), a determined efficiency in performance (e.g., energy consumption during the operation), etc. The observed outcomes may for example be provided as feedback (step 380) with respect to an operation being performed and correlated with the input data set for such an operation, for further development and/or training of the one or more models and/or algorithms based on the observed outcomes and at least the target values for the respective work machine operating parameters.

The observed outcomes may alternatively, for example, be provided as user input with respect to an actual operation, or in an embodiment with respect to simulated operation and associated simulation input data sets.

The learning stage 310 of the method 300 may optionally further include a step 316 of validation and storage of the trained models for selective retrieval during operation stages 320 of the method 300. For example, with one or more models having been validated as satisfying at least a minimum confidence level with respect to correlations between the input data sets and the respective outcomes, and without precluding further training of the models over time, the method 300 may proceed in association with current working operations.

The operation stage 320 of the illustrated method 300 may include a step 330 of receiving user input relating to an operation of the work machine, for example via user interface fields generated for prompting or otherwise enabling the user input. The user interface fields may be generated on an onboard display unit accessible to the operator and associated with a touch screen or keypad for user input.

The operation stage 320 of the illustrated method 300 may include a step 340 of presenting one or more selectable configurations based on the selected operation, for example via the same display unit used for the generated user interface fields. The selectable configurations may in some embodiments be presented as each of a plurality of configurations available to the work machine, for example based at least in part on the selected operation.

In some embodiments, the selectable configurations may be presented in the context of recommended configurations for selection by the operator, for example in order of priority of recommendation based on configurations relatively more likely to produce a desired outcome, based on historical experience of the operator, or the like.

Such recommendations may be presented by reference to the modeled correlations of operations and configurations with respect for example to desired outcomes, or may vary wherein the modeled correlations recognize that for a particular operator, working condition, etc., the otherwise optimal settings in association with a given configuration for one or more work machine operating parameters may be inapplicable, likely to be manually overridden, etc.

The operation stage 320 may further include a step 350 of receiving user input relating to the configuration for the work machine, again for example via user interface fields generated on a display unit accessible to the operator and associated with a touch screen or keypad for user input.

The operation stage 320 may continue with a step 360 for automatic setting of target values (e.g., binary values, variables, a range of values, minimum values, maximum values, etc.) for one or more operating parameters of the work machine, based on the selected configuration alone, or further in association with the previously selected operation. The functionality of the work machine can be optimally adapted to a desired outcome for the respective operation, and to the selected configuration, by setting one or more of these work machine operating parameters. The values for the operating parameters may for example be set by retrieving a model or algorithm from data storage based on the currently selected configuration, alone or further in view of the selected operation, optionally further in view of a selected or otherwise desired outcome, and applying the settings associated with the model or algorithm.

As previously noted, selectable configurations may for example relate to multiple portions of a selected operation, such as passes by the work machine. In some embodiments, only a single operation and a single configuration may need to be selected wherein values are automatically set for the work machine operating parameters to be retrieved and applied. In other embodiments, more than one operation and/or configuration may be selected, for example relating to sequential operations and configurations. In other embodiments, the presentations for operator selection may be represented as a hierarchy of queries for the operator, wherein each selection at a given level provides necessary input for presentation of a number of selectable options at a next level in the hierarchy, and wherein the number of levels may typically be two (i.e., operation-configuration) but is not necessarily limited thereto.

In an embodiment, the suitable values (or ranges, or minimum/maximum values) for the one or more work machine operating parameters may be displayed to the operator of the work machine, thereby making it easier for the operator to properly configure the work machine for the selected operation and reducing the potential for human error. Indication of the settings may be provided via an onboard display unit, or in some embodiments via optical or acoustic indicators that signal, for example, when an actual value does not match the specified value for a parameter, or when an actual value falls above or below a specified setting range. In an embodiment, alternative or additional feedback for the operator may include vibration or haptic feedback, again thereby making it easier for the operator to properly configure the work machine for the selected operation and reducing the potential for human error.

Alternatively, or in addition to, the display of the settings and manual control of the work machine, the operation stage 320 may continue with a step 370 of automatic control of the work machine, at least with respect to one or more of the work machine operating parameters having been set in the preceding step.

The method 300 may further include a feedback loop 380 as previously referenced, wherein input data sets associated with the current operation are provided as part of an iterative learning stage 310, optionally further in view of feedback input relating to outcomes of the current operation.

Embodiments of a method according to the present disclosure are described above in the context of a current and actual operation to be performed, or in the process of being performed (i.e., between passes of the operation). In some embodiments, the enabling of operator selection for a work machine operation and further presentation of various possible configurations may further be provided in the context of operator training and potentially separate from or otherwise independent of an actual operation. For example, an operator may be presented with a list of work machines, each type of work machine further associated with a list of potential operations, each operation further associated with a list of potential configurations, further optionally in view of work conditions or similar factors, wherein this presentation may be via a display unit onboard a work machine, or via an external computing device such as a mobile device associated with the operator. Such a training module may be executed as part of a web-based application, a mobile application, or the like.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method for automated setup of a work machine for performance of an upcoming operation, the method comprising:
generating one or more user interface fields enabling user input via a display unit associated with the work machine;
responsive to first user input corresponding to selection of a current operation, generating a group of one or more selectable configurations based on the current operation;
responsive to second user input corresponding to selection of one of the one or more selectable configurations, automatically setting respective target values for one or more work machine operating parameters based on the selected one of the one or more selectable configurations.

2. The method of claim 1, comprising automatically controlling the one or more work machine operating parameters during the operation of the work machine based on the respective target values.

3. The method of claim 2, wherein at least one of the one or more work machine operating parameters are associated with a position and/or orientation of a work machine implement for working a ground surface during the current operation.

4. The method of claim 2, wherein at least one of the one or more work machine operating parameters are associated with a specified path to be traversed by the work machine during at least a current portion of the current operation.

5. The method of claim 1, comprising automatically generating feedback prompting manual control of at least one of the one or more work machine operating parameters during or prior to the operation of the work machine based on the respective target values.

6. The method of claim 5, wherein the at least one of the one or more work machine operating parameters are associated with a position and/or orientation of a work machine implement for working a ground surface during the current operation.

7. The method of claim 5, wherein the at least one of the one or more work machine operating parameters are associated with a specified path to be traversed by the work machine during at least a current portion of the current operation.

8. The method of claim 5, wherein the generated feedback for prompting manual control comprises vibration or haptic feedback.

9. The method of claim 1, comprising:
a learning stage wherein historical input data sets are generated over time with respect to associated operations, configurations, and operating parameters, and wherein one or more models and/or algorithms are developed and/or trained to correlate the historical input data sets with observed outcomes;
wherein one of the one or more models and/or algorithms is retrieved in association with the selected current operation and/or the selected one of the one or more selectable configurations, and the respective target values for the one or more work machine operating parameters in association with the current operation are automatically set based at least in part on reference to the retrieved one of the one or more models and/or algorithms.

10. The method of claim 9, comprising observing one or more outcomes of performance of the current operation, and providing feedback for further development and/or training of the one or more models and/or algorithms based on the observed one or more outcomes and at least the corresponding target values for the one or more work machine operating parameters.

11. The method of claim 10, wherein the observed one or more outcomes comprise a determined speed of performance for the selected current operation, and/or a determined precision of the work machine in performing to target specifications for the selected current operation, and/or a determined efficiency in performance of the selected current operation.

12. The method of claim 1, wherein the selected one of the one or more selectable configurations corresponds to a current portion of the selected operation, the method comprising determining or predicting completion of the current portion and generating a prompt for further user input corresponding to selection of a configuration for a subsequent portion of the selected operation.

13. The method of claim 1, wherein the one or more user interface fields comprise a first user interface field including a group of one or more selectable operations, wherein the first user input comprises selection of one of the one or more selectable operations via the first user interface field.

14. The method of claim 1, wherein the one or more selectable configurations comprise at least one operating mode wherein the target values are automatically set for prioritizing a speed of performance for the operation, and/or at least one operating mode wherein the target values are automatically set for prioritizing a precision of the work machine in performing to target specifications for the operation, and/or at least one operating mode wherein the target values are automatically set for prioritizing an efficiency in performance of the operation.

15. A work machine comprising:
a frame supported by a plurality of ground-engaging units for propulsion of the work machine;
an implement controllably moveable relative to the frame; and
one or more processors configured to:
generate one or more user interface fields enabling user input via a display unit;
responsive to first user input corresponding to selection of a current operation, to generate a group of one or more selectable configurations based on the current operation; and
responsive to second user input corresponding to selection of one of the one or more selectable configurations, to automatically set respective target values for one or more work machine operating parameters based on the selected one of the one or more selectable configurations.

16. The work machine of claim 15, wherein the one or more processors are configured to automatically control the one or more work machine operating parameters during the operation of the work machine based on the respective target values.

17. The work machine of claim 15, wherein the one or more processors are configured to automatically generate feedback prompting manual control of at least one of the one or more work machine operating parameters during or prior to the operation of the work machine based on the respective target values.

18. A system for automated setup of a work machine for performance of an upcoming operation, the system comprising:
one or more processors configured to:
generate one or more user interface fields enabling user input via a display unit associated with the work machine;
responsive to first user input corresponding to selection of a current operation, generate a group of one or more selectable configurations based on the current operation;
responsive to second user input corresponding to selection of one of the one or more selectable configurations, automatically set respective target values for one or more work machine operating parameters based on the selected one of the one or more selectable configurations.

19. The system of claim 18, wherein the one or more processors are configured to automatically control the one or more work machine operating parameters during the operation of the work machine based on the respective target values.

20. The system of claim 18, wherein the one or more processors are configured to automatically generate feedback prompting manual control of at least one of the one or more work machine operating parameters during or prior to the operation of the work machine based on the respective target values.
